(19) United States
(12) Patent Application Publication
(10) Pub. No.: US 2024/0383071 A1
(43) Pub. Date: Nov. 21, 2024

(54) Method and Device for Laser Welding of Plate-Shaped Workpieces

(71) Applicant: ANDRITZ Soutec AG, Neftenbach (CH)

(72) Inventors: Hanspeter Meyer, Hüttwilen (CH); Jean-Frédéric Clerc, Bülach (CH)

(21) Appl. No.: 18/689,712

(22) PCT Filed: Jul. 29, 2022
(86) PCT No.: PCT/EP2022/071354

§ 371 Date: Mar. 6, 2024

(30) Foreign Application Priority Data
Sep. 27, 2021 (AT) A50762/2021

(51) Int. Cl. B23K 26/08; B23K 37/047

(52) U.S. Cl. CPC B23K 26/0838; B23K 37/047

(57) ABSTRACT

A device and a method for producing welded plate-shaped workpieces, in particular bipolar plates or heat exchanger plates. The workpieces are transported vertically on a horizontal plane XY by an endless circulating product transport system through a processing area and welded. The workpieces are transported through the processing area at a constant speed and are welded there by at least two welding lasers operating simultaneously, the position of the workpieces being determined and the at least two welding lasers being controlled thereby.

### BACKGROUND

The disclosed embodiments relate to a device and a method for laser welding of metallic components in an endless circulating transport system, in particular bipolar plates for fuel cells, for example in commercial vehicle manufacturing, or heat exchanger plates. Also disclosed are embodiments of the application of the method.

In the automotive industry, the trend is increasingly moving in the direction of reducing CO₂ and using alternative drive systems as a result of finite oil reserves and advancing global warming. Instead of combustion engines, electric motors with powerful batteries as storage medium are increasingly being used in cars and trucks. However, other technologies such as fuel cells will also become established in the future, particularly in the truck sector. Bipolar plates (BPP) are the main components of a fuel cell and therefore have a decisive influence on the manufacturing costs and efficiency of a fuel cell system. Due to several advantages in terms of manufacturability and material properties such as stability, low sheet thickness and a wide range of coating options, the metallic versions of bipolar plates are becoming the focus of research and development and are currently considered the preferred variant for future large-scale applications of fuel cells. A fuel cell system consists of a large number of individual cells, each with a BPP between the cells, with automotive applications typically requiring 300-400 bipolar plates per system. Due to the high number of BPPs per individual system, it can be assumed that the quantities required will quickly reach very large dimensions in the future, even under moderate scenarios. This challenge can also be seen as an opportunity for BPP suppliers. However, this requires economical and high-performance production technology. In particular, the welding of the two bipolar plate halves to form a BPP is a key problem due to the large number of weld seams, the associated long welding times and the high demands on the weld seams combined with very difficult process conditions due to the thin materials. At present, this is still a significant obstacle to cost-efficient production.

BPPs as such are known from the state of the art. They usually consist of two bipolar plate halves that are joined together. These are usually embossed foils or formed sheets. The bipolar plate halves lie on top of each other and are usually laser welded tightly at the lap joint. The laser produces several metres of weld seam and possibly additional spot welds. Resistance welding methods are also a known alternative. Here, welding devices are used, which often require the bipolar plate halves to be clamped several times in order to produce a seal contour and all the welding points. In order to be able to weld all sealing contours and points, the bipolar plate to be welded must be removed from the clamping device and re-clamped with another clamping or welding mask plate so that all areas of the BPP to be welded are accessible to the welding laser. Circumferential sealing contours are particularly problematic in manufacturing. If such sealing contours are produced with the laser in a single welding process, it may prove difficult to place additional clamping elements within the sealing contour to fix the bipolar plate halves within the surrounding welding contour. When the plates are re-clamped, there is a risk that the positioning will no longer match, welding points will be set in the wrong places and the bipolar plates will warp due to internal stresses released during re-clamping. In addition, the entire bipolar plate production process can be significantly delayed by re-clamping the half-finished bipolar plate.

The patent specification DE102016200387 describes a device and a method for producing a bipolar plate in which the distortion of the component is comparatively low. Welding energy is applied to the BPP from above and below. The position in the room where this is done is not described.

WO2018149959 shows a clamping device with clamping levers. From the image and text it can be concluded that the orientation of the BPP is horizontal, i.e. the surface lies horizontally on a base.

CN 108637476 A describes a device for welding bipolar plates with an electromagnetic clamping device, whereby the plates are welded horizontally with a welding laser.

CN 107350623 A describes a laser welding arrangement in which vertically positioned workpieces are mounted on a rotating platform and welded by a laser.

EP 3112074 A1 describes a nozzle changer for mounting and removing nozzles in a laser processing machine.

U.S. Pat. No. 6,639, 176 B1 describes a welding device in which metal sheets are welded together vertically to minimize the space required for the welding device.

DE 10 2017 202 426 A1 describes a method for separating flat workpieces using the TLS process (thermal laser beam separation).

GRÄBENER Maschinentechnik shows a complete production line for BPP on its homepage. Two welding systems are also shown in detail at https://www.graebener.com/en/cutting-and-welding. BPP are welded horizontally at standstill.

The company SITEC HTTPS://WWW.SITEC-TECHNOLOGY.DE/manufactures automated laser welding systems, whereby welding is also carried out at a standstill and in a horizontal plane.

European patent specification EP3038789 describes a method for increasing cycle times and thus reducing production costs in the industrial production of welded sheet metal parts—in particular, tailored blanks for the automotive industry. The method is based on a transport system with flying optics and horizontal alignment of the workpiece during welding, and does not require any complex cooling of the hot weld seam or any means of holding the workpieces with high force on one side of the conveyor belt. This can greatly reduce the negative impact of the gap between blanks on the machine's cycle time. Overall, the method can reduce non-productive welding time.

However, in such a system with vertical movement, the return path of the conveyor system cannot be used for manipulation unless access is gained from the underside of the machine. The method described is based on a static laser beam. It is therefore not possible to move the laser beam transversely to the transport direction. In addition, the entire laser optics must be moved, which has negative consequences in terms of dynamics, accuracy, and power requirements due to the large mass. Since the ratio of chain link length to chain deflection radius is often very large, a chain drive using a sprocket wheel induces a significant positional error in the chain due to the well-known polygon effect. It is common practice to compensate for this undesirable effect at least on one side (in the forward run) with an electronic cam disc on the chain drive, for example, but this is only possible with limited accuracy due to the given, non-steady kinematics and the masses. In the case of a chain with two deflections, however, the counter links of the chain (in the return direction) may be overcompensated (back and forth acceleration during movement), and it becomes very difficult to synchronise a function with this strand. The polygon effect not only affects the dynamics, but also the chain length itself. This change in chain length must therefore be compensated for by at least a dynamic chain tensioner or a compensating deflection curve to maintain a more or less constant chain tension. Chains that are not pre-tensioned can generate chaotic vibrations and thus cause additional inaccuracies.

The disadvantages of the aforementioned solutions are the high technical effort required to reliably clamp the components, the large machine dimensions with high investment costs, and the overall low productivity of the entire system.

### SUMMARY

The disclosure provides a device and a method by which the above-mentioned disadvantages are eliminated.

In the disclosed device, the workpieces, which generally consist of two metal plates placed on top of each other, are transported and welded in a horizontal plane. In doing so, the plate-shaped workpieces are in a vertical position, i.e. perpendicular. In conventional systems, on the other hand, the workpieces are welded in a horizontal position. One advantage is therefore that the welding process takes place vertically, i.e. in perpendicular direction and approximately vertically to the transport direction. This means that welding spatter does not remain on the workpiece being processed, resulting in less contamination of the workpieces and the device.

According to the inventive disclosed embodiments, the workpieces are transported at a constant speed in the processing area, where they are welded by at least two welding lasers operating simultaneously. Position measurement is also provided to determine the position of the workpieces. The position measurement is used to control at least two welding lasers.

Preferably, more than two welding lasers working in parallel are provided; for example, arrangements with 8 welding lasers are also possible.

In order to move parts through the processing area at a constant speed, the polygon effect must be compensated for. This can be done using a helix, for example. All chain links that are currently located in the processing area are engaged with the screw (helix) that is located in that area during the processing phase. This results in a more precise alignment of the chain links to each other, and thus an increase in quality. The moving counter links of the chain, with no superimposed accelerations, allows the chain links to be loaded and unloaded with workpieces without the need for complex positional compensation, making optimum use of the available space.

Furthermore, the use of multiple welding lasers allows for increased production. The laser beams can process one workpiece at a time and then immediately move on to the next workpiece.

The welding lasers, which are positioned as close together as possible, also reduce cycle time, and create additional installation space. The use of special laser optics also allows a large processing area to be processed without the laser optics moving relative to the product transport system.

In the proposed configuration, the workpiece is clamped only once and then welded, eliminating repeated clamping with the known problems of precise adjustment during welding of the workpiece and achieving a high level of overall accuracy during loading, welding, and unloading.

The aim is to significantly increase part output per time unit while simultaneously reducing part costs. The use of laser optics allows a large processing area without the need for the laser optics to move relative to the product transport device, resulting in an increase in quality. Overlapping laser beams and simultaneous multi-pitch welding allow for optimal laser utilisation, compact design, and extremely long weld seams in the shortest possible time, reducing processing costs.

Hence, the disclosed embodiments presented herein enables efficient and high-quality production overall.

### BRIEF DESCRIPTION OF THE DRAWINGS

The present invention is further explained in the following on the basis of example embodiments and referring to drawings. In the drawings,

FIG. 1 is a schematic top view of a first laser processing and product transport system,

FIG. 2 is a schematic top view of a second, alternative laser processing and product transport system,

FIG. 3 is a schematic top view of a third, alternative laser processing and product transport system, and

FIG. 4 is a schematic side view of the first laser processing and product transport system.

### DETAILED DESCRIPTION

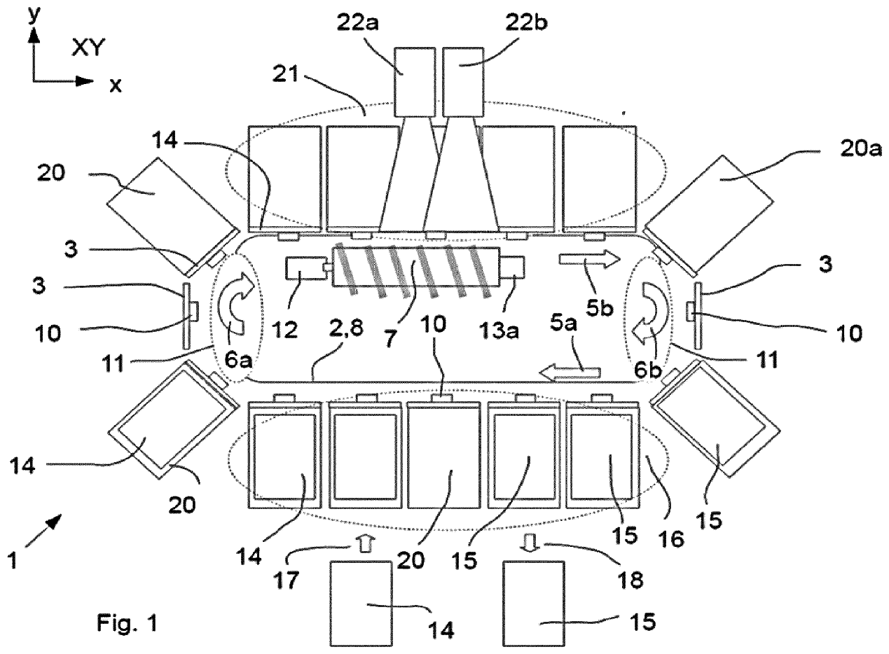

FIG. 1 shows a top view of a first laser processing and transport system 1, with the endlessly circulating product transport system 2 and the at least one product transport system guide 8. The product transport system 2 is moved clockwise in the transport plane XY (horizontal plane) by means of a screw drive 12 with rotary encoder 13a and passes through the linear areas 5a,5b and the curve areas 6a, 6b in the compensation deflection curves 11. The product transport system 2, for example a chain-driven system, consists of a number of conveyor links 3, for example chain links, which are each provided with a swivelling folding lever 20 and at least one guide roller 10 each, which engage in the helix 7. Loading 17 of the welding devices of the circulating product transport system 2 with a workpiece 14 takes place in the linear area 5a with the folding lever 20 folded out and lying horizontally in the loading/unloading zone 16. In the curve area 6a, the workpiece 14 is brought into a vertical position by folding up the folding lever 20 and fixed in the welding device, for example with the aid of magnetic forces. In the next step, the folding lever 20 is opened again and brought into an approximately horizontal position. The workpiece remains in the vertical position. In the linear area 5b, the workpiece 14 is welded in the laser processing zone 21 using the fixed welding lasers 22a, 22b. The workpieces 14 are moved past the welding lasers 22a, 22b in the laser processing zone 21 by means of the product transport system 2. In the loading/unloading zone 16, the processed (welded) workpiece 15 is removed from the endlessly circulating product transport system 2 by unloading 18 the welding device.

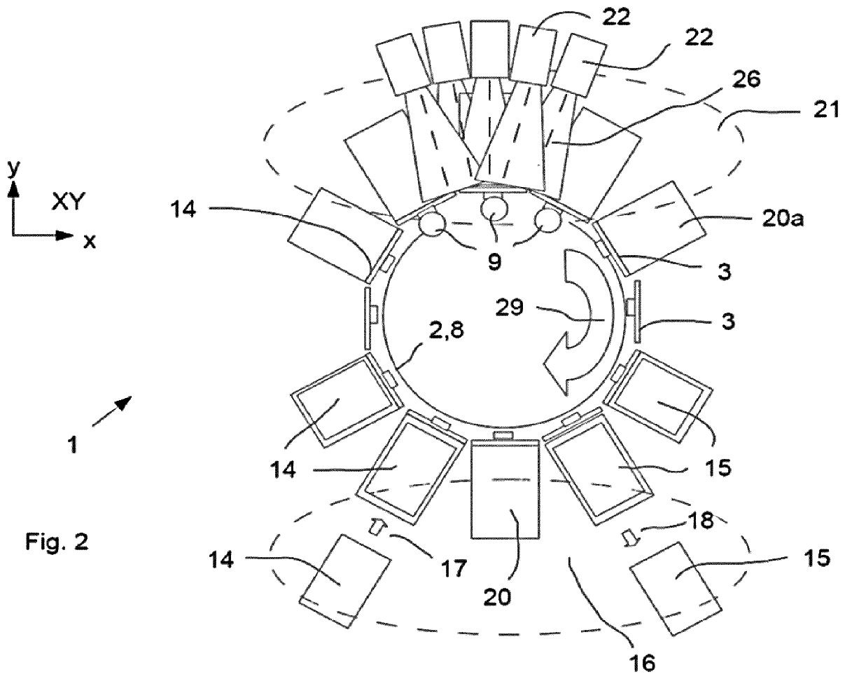

FIG. 2 shows a top view of a second, alternative laser processing and transport system 1, with the endlessly rotating product transport system 2, which is provided with drive means and moves in a uniform clockwise rotational movement on the circular path 29 in the transport plane XY (horizontal plane). The product transport system 2 consists of a number of conveyor links 3, each of which is equipped with a swivelling folding lever 20. The loading 17 of the welding device of the circulating product transport system 2 with a workpiece 14 to be welded, takes place in the loading/unloading zone 16 with the folding lever 20 folded out and lying horizontally. By folding back the folding lever 20, the workpiece 14 is brought into a vertical position and fixed in the welding device. In the next step, the folding lever 20 is opened again and brought back into an approximately horizontal position. In the laser processing zone 21, continuous position measurement 9 and welding of the workpiece 14 takes place using laser beams 26 from at least two welding lasers 22, which are positioned as close together as possible. 5 welding lasers 22 are shown here, but various other numbers of welding lasers 22 are possible. The workpieces 14 are moved past the welding lasers 22,22a,22b in the welding plane by means of the product transport system 2. In the loading/unloading zone 16, the processed workpiece 15 is removed from the endlessly circulating product transport system 2 by unloading 18 the welding device.

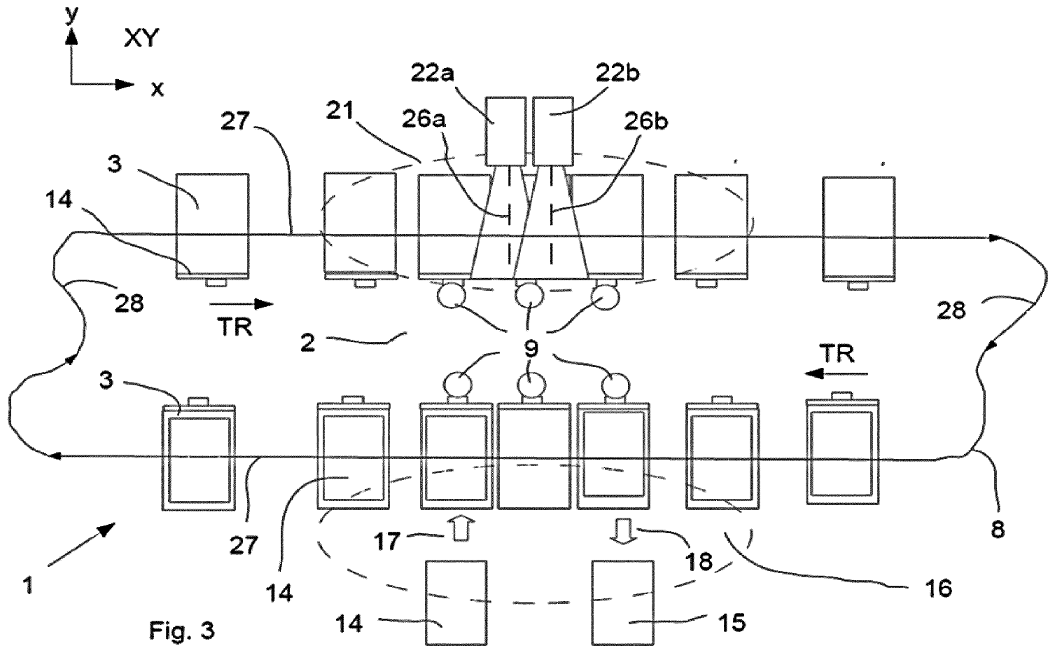

FIG. 3 shows a top view of a third, alternative laser processing and transport system 1 with the product transport system 2 and the at least one product transport system guidance 8. The conveyor links 3 are provided with drive means, for example motorised conveyor trolleys, and move along a fixed path 27 with a fixed spacing and a free path 28 with a free spacing in the transport direction TR in the transport plane XY. The drive means can be linear motors, for example. The loading 17 of the welding device of the circulating product transport system 3 with the workpieces 14 to be welded, takes place in the loading/unloading zone 16 on the fixed path 27. In the laser processing zone 21, which is also located on the fixed path 27, a continuous linear position measurement 9 is carried out and the workpiece 14 to be welded is processed by means of the at least two laser beams 26a,26b of the at least two welding lasers 22a,22b. The workpiece 14 is moved past the welding lasers 22a,22b in the welding plane by means of the product transport system 2. In the loading/unloading zone 16, the welded workpiece 15 is removed from the endlessly circulating product transport system 2 by unloading 18 the welding device.

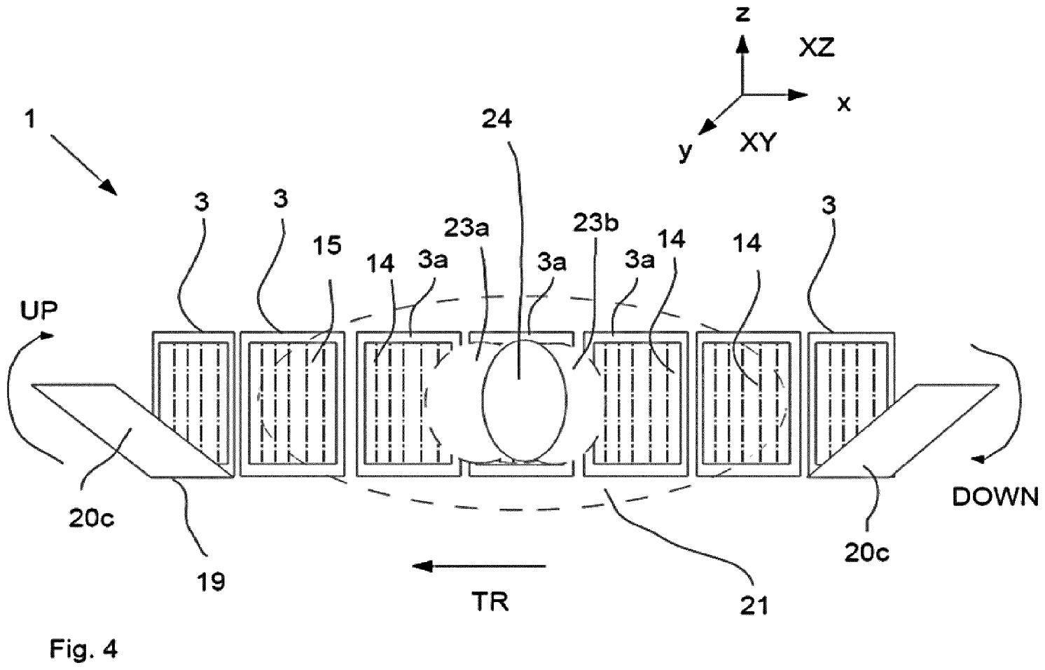

FIG. 4 shows a side view of the laser processing zone 21 of a laser processing and transport system 1, with the circulating product transport system 2, whose conveyor links 3 move continuously in the transport plane XY (horizontal plane) in the transport direction TR. The workpieces 14 to be welded are fixed on the conveyor links 3 and are welded in the welding plane XZ. The at least two welding lasers cover the processing areas 23a,23b at the current separation positions 3a, resulting in an overlap 24 of the processing areas 23a,23b. The folding levers 20 can be swivelled around the swivelling axis 19 and are used to position and fix the workpieces 14 to be welded and the welded workpieces 15 on the conveyor links 3. The folding levers 20 are shown in the “half open 20c” position in the “fold down” DOWN or “fold up” UP state.

### REFERENCE NUMERALS

1 Laser processing and transport system
2 Product transport system
3 Conveyor link
3a Current separation position
5a,5b linear range
6a,6b Curve area
7 Helix
8 Product transport system guidance
10 Guide roller
11 Compensation deflection curve
12 Screw drive
13a Rotary encoder
9 Position measurement
14 Plate-shaped workpiece
15 Machined workpiece
16 Loading/unloading zone
17 Loading
18 Unloading
19 Swivelling axle
20 Folding lever
20a Folding lever open
20b Folding lever closed
20c Half-open folding lever
21 Laser processing zone
22 Welding laser
22a Welding laser
22b Welding laser
23a,23b Processing area
24 Overlap
26,26a,26b Laser beam
27 Fixed path
28 Free path
29 Circular path
TR Transport direction
XY Transport plane (horizontal plane)
XZ Welding plane

1-12. (canceled)

13. A device for producing welded plate-shaped workpieces (14, 15), the plate-shaped workpieces (14) being welded vertically in a processing area (23a, 23b) with a welding laser (22, 22a, 22b), comprising:
an endlessly circulating product transport system (2) in a substantially horizontal plane XY having a plurality of conveyor links (3) each configured for fixing a plate-shaped workpiece (14) and transporting them substantially vertically through the processing area (23a, 23b);
a drive mechanism (12) configured for transporting the plurality of conveyor links (3) through the processing area (23a, 23b) at a substantially constant speed by a drive mechanism (12);
at least two welding lasers (22, 22a, 22b) being operating simultaneously and configured for welding the workpieces (14) in the processing area (23a, 23b); and
a position measuring device (9) configured for determining the position of the workpieces (14) and for controlling the at least two welding lasers (22, 22a, 22b).

14. The device according to claim 13, wherein each of the at least two welding lasers (22, 22a, 22b) is provided with an optical system for deflecting laser beams (26, 26a, 26b) in substantially horizontal and substantially vertical directions, thereby reaching each point on a surface of the workpieces (14).

15. The device according to claim 14, wherein the drive mechanism (12) comprises a screw drive (12) with helix (7) or a linear motor.

16. The device according to claim 13, wherein the drive mechanism (12) comprises a screw drive (12) with helix (7) or a linear motor.

17. The device according to claim 16, wherein the at least two welding lasers (22, 22a, 22b) includes more than two welding lasers.

18. The device according to claim 13, wherein the at least two welding lasers (22, 22a, 22b) includes more than two welding lasers.

19. The device according to claim 13, wherein the conveyor links (3) comprise chain links or conveyor trolleys.

20. The device according to claim 18, wherein the at least two welding lasers (22, 22a, 22b) are arranged in a fixed position and the laser beams (26, 26a, 26b) are repositionable via a mirror system for thereby repositioning the laser beams (26, 26a, 26b) from a first workpiece (14) to a following workpiece (14) on a following conveyor link (3).

21. The device according to claim 16, wherein the at least two welding lasers (22, 22a, 22b) are arranged in a fixed position and the laser beams (26, 26a, 26b) are repositionable via a mirror system for thereby repositioning the laser beams (26, 26a, 26b) from a first workpiece (14) to a following workpiece (14) on a following conveyor link (3).

22. The device according to claim 13, wherein the at least two welding lasers (22, 22a, 22b) are arranged in a fixed position and the laser beams (26, 26a, 26b) are repositionable via a mirror system for thereby repositioning the laser beams (26, 26a, 26b) from a first workpiece (14) to a following workpiece (14) on a following conveyor link (3).

23. The device according to claim 16, wherein the workpieces (14) are fixed to the conveyor links (3) perpendicular to the transport plane XY via folding levers (20a, 20c).

24. The device according to claim 18, wherein the workpieces (14) are fixed to the conveyor links (3) perpendicular to the transport plane XY via folding levers (20a, 20c).

25. The device according to claim 22, wherein the workpieces (14) are fixed to the conveyor links (3) perpendicular to the transport plane XY via folding levers (20a, 20c).

26. The device according to claim 13, wherein the workpieces (14) are fixed to the conveyor links (3) perpendicular to the transport plane XY via folding levers (20a, 20c).

27. The device according to claim 13, wherein the workpieces (14) comprise bipolar plates or heat exchanger plates.

28. A method for producing welded plate-shaped workpieces (14, 15), the plate-shaped workpieces (14) being welded in a processing area (23a, 23b), comprising:
transporting the workpieces (14) substantially vertically on conveyor links (3) via an endlessly circulating product transport system (2) in a substantially horizontal plane XY;
moving the conveyor links (3) through the processing area (23a, 23b) at a constant speed; and
determining the position of the workpieces (14) and thereby controlling at least two welding lasers (22, 22a, 22b) to weld the workpieces (14) in the processing area (23a, 23b), wherein
the at least two welding lasers (22, 22a, 22b) are operated simultaneously.

29. The method according to claim 28, comprising guiding the workpieces (14) on a horizontal straight line in the processing area (23a, 23b).

30. The method according to claim 28, wherein the workpieces (14) are guided on a circular path (29) in the processing area.

31. The method according to claim 28, wherein the arrangement of the at least two welding lasers (22, 22a, 22b) achieves an overlap (24) of welding areas.

32. An application of the method according to claim 28, wherein the workpieces (14) comprise bipolar plates for fuel cells or for heat exchanger plates for transferring thermal energy.
